(19) United States
(12) Patent Application Publication
(10) Pub. No.: US 2016/0053159 A1
(43) Pub. Date: Feb. 25, 2016

(54) NON-TOXIC AND BIODEGRADABLE SURFACTANTS

(71) Applicant: Prochem International BV, Almere (NL)

(72) Inventors: Mark Anton Ploegmakers, Naarden (NL); Gergard Henri Meijer, Newburgh, IN (US); Ron van Petegem, Montgomery, TX (US)

(73) Assignee: Prochem International BV, Almere (NL)

(21) Appl. No.: 14/788,055

(22) Filed: Jun. 30, 2015

Related U.S. Application Data
(60) Provisional application No. 62/041,441, filed on Aug. 25, 2014.

(51) Int. Cl. C09K 8/60; E21B 43/26

(52) U.S. Cl. CPC C09K 8/604; E21B 43/26

(57) ABSTRACT

The invention is the use and application of a system having a non-toxic and biodegradable surfactant, which is not ethoxylated and is built up from alkyl polyglycoside derivatives, for use in the oilfield industry to mitigate the release of toxic chemicals into the environment. Where the surfactant system incorporates a non-ethoxylated polymerized sugar for use in downhole and surface applications in the oilfield industry. The use of alkyl polyglycoside derivatives allows the creation of surfactants, which are water soluble without any ethylene oxide or propylene oxide groups attached to the main carbon backbone of the molecule. By not ethoxylating and/or propoxylating the alkyl-backbone no 1,4-dioxane is produced as a by-product therefore there are no traces of this molecule in the surfactant produced using alkyl polyglycoside derivatives. Additionally, these surfactants do not contain nonyl, butyl, or other alkylphenol groups.

### CROSS-REFERENCE TO RELATED APPLICATIONS

This application claims priority to U.S. Provisional Patent Application No. 62/041,441 that was filed on Aug. 25, 2014.

### FIELD OF INVENTION

The invention is the use and application of non-toxic and biodegradable surfactants, including non-ethoxylated polymerized sugar, for use in the oilfield industry while reducing or eliminating the risk of release of toxic chemicals in the environment

### BACKGROUND

Conventional surfactants are non-ionic and are used in various oil and gas applications, both downhole and surface, where the surfactant needs to act as a non-emulsifier, a flow back enhancer, a cleaner, or for enhanced oil recovery purposes. Conventional surfactants may also be toxic to aquatic organisms.

The nonionic surfactants, or surface-active molecules, can be used in the aforementioned applications as they lower the surface tension of water based fluids, the interfacial tension between water and oil, and the capillary pressure. Being nonionic allows the use of these surfactants without the surfactants reacting, inside the water based fluid systems, with other chemical ingredients that may be present.

Nonionic surfactants are made through ethoxylation and/or propoxylation, an industrial process in which ethylene oxide and or propylene oxide is added to a fatty alcohol, fatty amine, or phenol to turn it into a surfactant. Common surfactants produced by ethoxylation include alcohol ethoxylates, alcohol ethoxy sulfates or alcohol phenol ethoxylates.

In particular alcohol ethoxylates are formed via ethoxylation, where an alcohol is placed in a reactor and treated with ethylene oxide and potassium hydroxide, which serves as a catalyst. The reactor is pressurized with nitrogen and heated to about 150° C. Typically 5-10 units of ethylene oxide are added to each alcohol, where:

ROH+n C₂H₄O→R(OC₂H₄)ₙOH
R has 8-22 carbon atoms

The amount of ethylene oxide and the reaction time determine the degree of ethoxylation (the value of n in the equation above), which in turn determines the surfactant properties of the ethoxylated product. Ethoxylation makes the long chain alcohol, amine, or phenol water soluble. The hydrophilicity of the surfactant increases with the value of n.

The ethoxylated portion of such a surfactant is the hydrophilic portion of the surfactant while the alkyl or alkylphenol chain is the lipophilic portion of the surfactant. The alkyl or alkylphenol chain can be either linear or branched.

During the ethoxylation or propoxylation of fatty amines, fatty alcohols, or phenols, the by-product 1,4-dioxane is created. 1,4-dioxane is carcinogenic and moves rapidly into groundwater. 1,4 dioxane degrades very slowly therefore it is usually stripped off during the ethoxylation process. However, it is impossible to remove it 100% from the ethoxylated or propoxylated surfactants, therefore at least trace amounts of 1,4-dioxane are always present.

Both linear and branched alcohol ethoxylates with a similar amount of carbon atoms have similar toxicity values for aquatic organisms. The toxicity mechanism for alcohol ethoxylate is generally accepted as non-polar narcosis. Surfactants with a longer alkyl chain and good water solubility have a higher toxicity as they are more efficient at penetration of the cell membrane.

Toxicity tests in fresh and salt water are carried out with aquatic organisms. The amount of chemical in water (in parts per million) that kills of 50% of the total present population in the water is referred to as the LC50 value. The EC50 value is the amount of chemical inside the water (in parts per million) that disturbs the growth of 50% of the total present population of organisms in the water.

Toxicity is measured normally on three different aquatic organisms; algae, invertebrates such as Daphnia Magna, and fish.

Surfactants are toxic to algae and as the surfactants' long chain molecules inhibit growth they encapsulate the algae. The majority of all conventional surfactants are toxic to algae with a few exceptions of poorly water soluble, long chain alcohol ethoxylate's with a high ethylene oxide number.

One of the most sensitive fresh water invertebrates to surfactants is Daphnia Magna, 90% of all alcohol ethoxylate's are toxic to this organism having an EC50 value of less than 10 ppm.

When surfactants are tested upon fish, surfactants tend to settle inside the fish's gills, either making them sick or killing them. Alcohol ethoxylate's obtain low scores during such testing with more than 90% of these surfactants having LC50 or EC50 values close to 1 ppm with only a few exceptions having a value more than 10 ppm. Therefore conventional ethoxylated surfactants are harmful to the environment.

The Centre for Environment, Fisheries and Aquaculture Science (CEFAS) is the regulatory body in the United Kingdom that sets the standards on the offshore use of chemicals in the oilfield industry,

CEFAS requires that each chemical used in the North Sea is tested for toxicity, biodegradability, bioaccumulation. The Log P_{OW} test is meant to predict the likelihood of bioaccumulation of a product. One definition of this test is:

$$Log {P}_{OW} = Log \frac{{c}_{octanol}}{{c}_{water} }$$

An organic compound's octanol-water partition coefficient, P_{OW}, is defined as the ratio of the compound's concentration in a known volume of n-octanol to its concentration in a known volume of water after the octanol and water have reached equilibrium. Water solubility was found to be the major factor affecting the partition coefficient. If the Log P_{OW} value>3.0, then the organic compound has failed the test and the product is considered to have a greater than wanted tendency to bio-accumulate.

Ethoxylated and propoxylated surfactants virtually always fail this test and get scores larger than 3. This is due to their high surface active characteristics. Since surfactants contain both lipophilic and hydrophilic parts, they will tend to settle in both the octanol and water.

Ethoxylated and propoxylated surfactants are tested for toxicity in three ways, by EC50 72 hours growth inhibition to algae, LC50 10 days static sediment test, and LC50 96 hours marine fish toxicity test. Minimum values for all toxicity tests are set at 10 ppm. If the EC50 or LC50 values are <10 ppm, then the tested surfactant has failed and the result is negative.

Ethoxylated and propoxylated surfactants are tested for biodegradability in sea water via the closed bottle test. In the closed bottle test how much of the mass of the chemical biodegrades in saltwater is measured. The minimum biodegradation should be at least 60% over 28 days. If in 28 days less than 60% of the tested surfactant has biodegraded then the surfactant has failed the test.

CEFAS uses the results obtained in tests 1, 2 and 3 as described earlier to determine whether or not or what kind of warning and recommendations to make as to each chemical product submitted to CEFAS for use in the North Sea. When a chemical product fans 2 out of 3 tests the product will get either a red color-code (Denmark or Norway), a substitution warning (UK) or is placed in Category C or D (Netherlands), where if there is another less toxic product that product must be used in place of the more toxic chemical product.

All conventional non-ionic surfactants, used in the North Sea and are made through ethoxylation, have received the red color code and substitution warning. Because they all fail on the Log P_{OW} test, this means that they have poor biodegradation, are too toxic, or both. Virtually all conventional alcohol ethoxylate's will not pass the toxicity tests for salt water.

In the search for “greener” surfactants, the industry has begun to use fatty alcohols from renewable sources such as linseed, soya. coconut oils, or corn starch. However, the moment they are ethoxylated, a surfactant is produced which has either poor biodegradation and/or is toxic to the environment.

Other attempts to produce greener surface active products have been made by trying to use alkyl polyglycosides as they have surface tension reducing capabilities, biodegrade well, and have low toxicity. The main problem remains their poor water solubility. These alkyl polyglycosides are ethoxylated to enhance the water solubility, again making them toxic for the environment.

### SUMMARY

An embodiment of the invention is the use and application of non-toxic and biodegradable surfactants, such as non-ethoxylated polymerized sugar, for use in downhole- and surface applications in the oilfield industry while reducing or eliminating the risk of release of toxic chemicals in the environment.

This embodiment is related to the use of non-toxic and biodegradable surfactants which are made out of renewable sources and which were made as described in this invention and not made water soluble through ethoxylation and propoxylation. In other words, our invention describes how non-toxic and biodegradable surfactants can replace conventional prepared surfactants and often even outperform them.

An embodiment is the use of a non-ethoxylated polymerized sugar as an ingredient to manufacture non-toxic biodegradable surfactants for the use in certain downhole and surface applications in the oilfield industry. By not ethoxylating and/or propoxylating the alkyl-backbone, no 1,4-dioxane is produced as a by-product therefore there are no traces of this molecule in the surfactant produced using alkyl polyglycoside derivatives. Additionally, these surfactants do not contain nonyl, butyl, or other alkylphenol groups.

Using non-ethoxylated polymerized sugars, as a component of a surfactant has resulted in the creation of surfactants which are, on average, 100 times less toxic than conventional ethoxylated surfactants for aquatic life. The surfactants created are non-toxic, biodegradable, non-flammable, lower the surface tension of water to 35 Dynes/cm, quickly break oil/water emulsions within a wide temperature range and are nonionic/slightly anionic. All environmental tests, in both fresh and salt water showed that our surfactants are truly green to current standards as they are proven non-toxic and biodegradable.

An oil well may be any subterranean well that is constructed to produce or inject hydrocarbons, fluids, or mixtures of fluids and hydrocarbons. An oil well may be constructed on land, on a platform offshore, or from floating or suspended structures.

### BRIEF DESCRIPTION OF THE DRAWINGS

FIG. 1 is a depiction of an onshore well undergoing stimulation by injecting a surfactant having a non-ethoxylated polymerized sugar.

FIG. 2 is a depiction of a surfactant having a non-ethoxylated polymerized sugar being injected in a first well to push fluids towards a second well.

FIG. 3 is a depiction of the injection of a surfactant having a non-ethoxylated polymerized sugar into an offshore well.

### DETAILED DESCRIPTION

The description that follows includes exemplary apparatus, methods, techniques, or instruction sequences that embody techniques of the inventive subject matter. However, it is understood that the described embodiments may be practiced without these specific details.

In one embodiment of the invention, the surfactant having a non-ethoxylated polymerized sugar is added to a water based fluid where the fluid will be used for stimulating the well and may contain another single chemical or a plurality of chemicals.

Typically the stimulating fluid is to enhance the production of hydrocarbons or injectivity of the oil well in a process referred to as well stimulation. Well stimulation is done on and off shore. A stimulating fluid can be placed under a pressure greater than the fracturing gradient of the formation for the purpose of creating fractures inside the formation. This may increase the amount of hydrocarbons produced per day and/or may increase the total volume of hydrocarbons that could be recovered from a hydrocarbon containing reservoir. This process is known to the industry as fracturing and can be done with a water based or non-aqueous fluid. It can also be placed, squeezed, or pumped into the formation below the fracture gradient for purposes such as but not limited to the enhancement of hydrocarbon production, scale removal, or elimination of near wellbore damage.

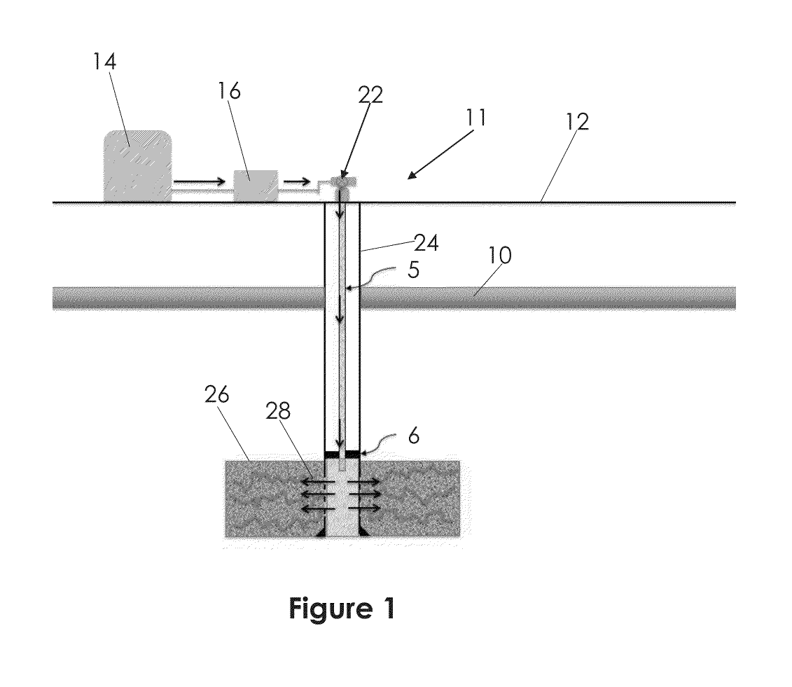

As described in FIG. 1 the use of a surfactant having a non-ethoxylated polymerized sugar as described in this document eliminates or reduces the risk of release of toxic chemicals in the environment, groundwater, sea, or aquifer 10. During the preparation process of the stimulating fluid at the surface 12, the pumping process, as well as during the back flow, there is a risk of a spill or leakage of the stimulating fluid and stimulation chemicals may come in contact with the surface soils, ground water, sea, or aquifer 10.

The low toxicity and biodegradability of the surfactant having a non-ethoxylated polymerized sugar, in both fresh and salt water, eliminates or reduces the risk of release of toxic chemicals in the environment.

The surfactant having a non-ethoxylated polymerized sugar is added to the stimulating fluid. The amount of the surfactant having a non-ethoxylated polymerized sugar added to the stimulating fluid can be between 0.001 and 99% by volume. Based on the design of the stimulating fluid and the expected functionality of the surfactant having a non-ethoxylated polymerized sugar, the amount and rate of adding the surfactant having a non-ethoxylated polymerized sugar may be determined.

If the surfactant having a non-ethoxylated polymerized sugar is added at surface to the stimulating fluid, inside a blending tank 14. The surfactant having a non-ethoxylated polymerized sugar is typically dissolved or suspended in the stimulating fluid in the blending tank all though it may be dispersed throughout the stimulating fluid by other means.

The surfactant having a non-ethoxylated polymerized sugar can be added to the stimulating fluid by adding it to the stimulating fluid as it is being placed into the well, commonly referred to as “mixing on-the-fly”. The surfactant having a non-ethoxylated polymerized sugar is added to the stimulating fluid to lower the surface tension of the stimulating fluid. As a result of lowering the surface tension of the stimulating fluid, the risk that the stimulating fluid emulsifies the hydrocarbons inside the reservoir or formation is eliminated or reduced. If during the pumping of the stimulating fluids or during the flow back of the stimulating fluids emulsions are still forming, then the presence of the surfactant having a non-ethoxylated polymerized sugar will allow the formed emulsion or emulsions to break into an oil and water phase.

The surfactant having a non-ethoxylated polymerized sugar, when added to the stimulating fluid, will reduce the surface tension and increase the contact angle and as such alters the capillary pressure in the formation. Decreasing the surface tension and increasing the contact angle, enhances the phase separation of the stimulation and reservoir fluids.

Most commonly the stimulating fluid is placed inside the well using a pump 16 although other methods such as compressed air may also be used. The stimulating fluid including the surfactant having a non-ethoxylated polymerized sugar is typically placed downhole through the wellhead 22 in the production or work tubular 24. The stimulating fluid is placed inside formation 26 through ports 28 in the tubular 24. Optionally after the stimulating fluid is placed inside formation 26, the well 11 is produced to remove some or all of the stimulating fluids from the well.

The use of this surfactant having a non-ethoxylated polymerized sugar eliminates or lowers the risk of release of toxic chemicals in the environment, groundwater, sea, or aquifer 10. During the preparation of the stimulating fluid at the surface 12, the placement process, or during flow back, there is a chance, because of a spill or leakage of the stimulating fluid, that chemicals end up inside the ground water, sea, or aquifer 10. The low toxicity and biodegradability in both fresh and salt water of this surfactant having a non-ethoxylated polymerized sugar mitigates the risk of release of toxic chemicals in the environment.

In another embodiment of the invention, the surfactant having a non-ethoxylated polymerized sugar is added to a fluid to enhance the cleaning properties of the fluid. This fluid may contain another chemical or multiple chemicals.

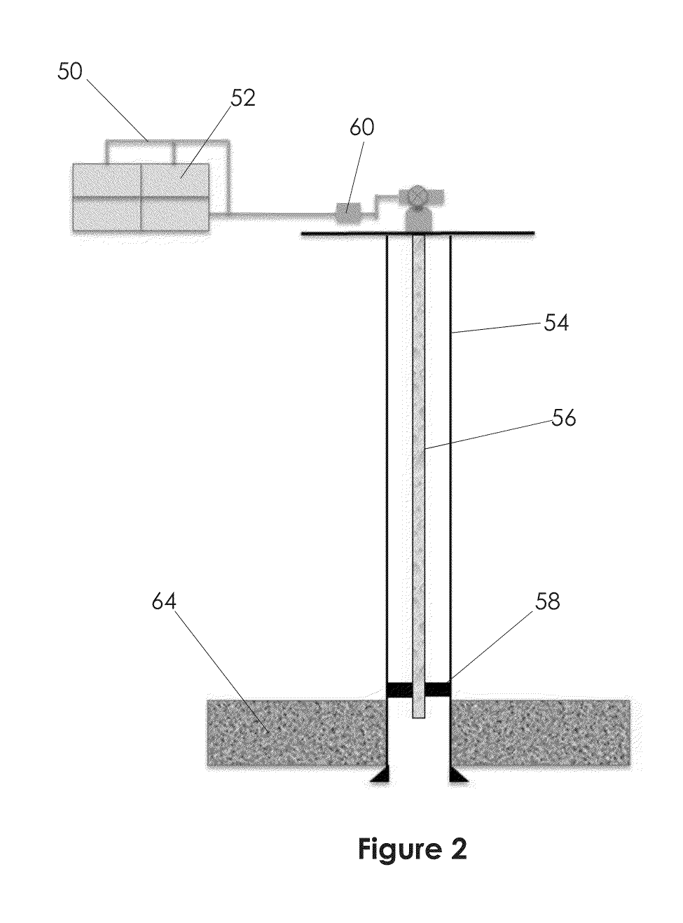

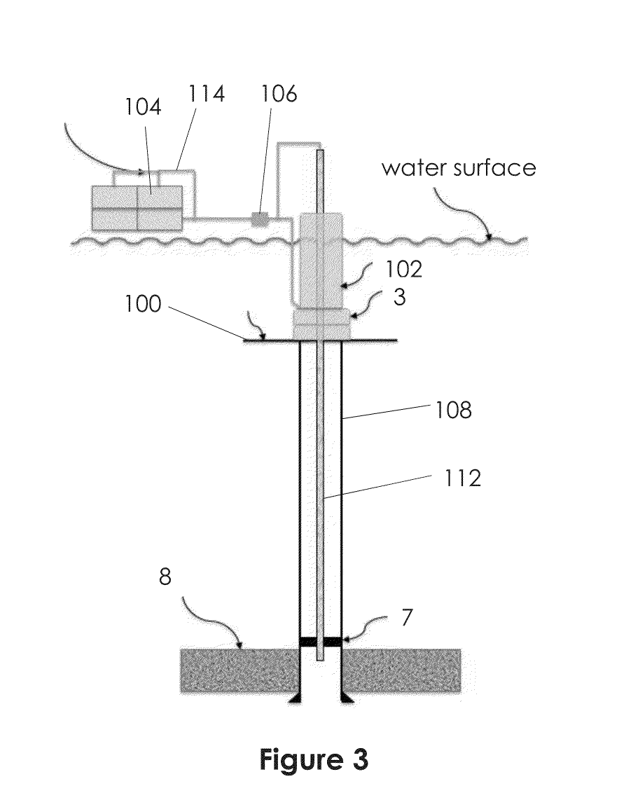

An example of a possible onshore rig set up is shown in FIG. 2. Where the fluid is injected into a first well to drive downhole fluids towards a second well and to open fluid pathways as the surfactant having a non-ethoxylated polymerized sugar moves through the well. In the FIG. 3 shows a possible rig set up for an offshore well.

Cleaning, diluting or removing contaminants from any type of equipment at surface is mostly done to prevent impairment to the overall production system, but also for reasons such as safety, overall hygiene and cleanness, and/or environmental reasons. This surface equipment can be onshore as depicted in FIG. 2 or offshore as depicted in FIG. 3. It may include a drilling rig, production platform, wellhead, workover rig, pipelines, well bore tubulars for the transport of produced or injected fluids, blending and storage tanks, heat exchangers, and mixers.

Offshore deep-water installations also contain sub-sea equipment as shown in FIG. 3 which is placed on the sea-bed 100. On top sits a riser 102. Sub-sea equipment may include a drilling riser, production riser, umbilical, sub-sea pipe line, sub-sea well head, sub-sea manifold, sub-sea production system, etc.

Sub-sea equipment can be cleaned with the cleaning fluid by pumping it from the surface equipment 104 with a pump or other system 106 inside the downhole or wellbore tubulars such as casing 108 and workstring 112.

If contaminants end up in the environment, they may contaminate the soil, groundwater, aquifer and sea. Removing such contaminants from surface based equipment may prevent this from happening. Contaminants can also make equipment slippery which makes it more hazardous for employees who operate the equipment. The cleaning of surface, subsurface, or downhole equipment may also enhance production efficiency.

The surfactant having a non-ethoxylated polymerized sugar is added to the base fluid to create the cleaning fluid. The amount of surfactant having a non-ethoxylated polymerized sugar added to a fluid can be between 0.001 and 99% by volume. The amount of the surfactant having a non-ethoxylated polymerized sugar added is based on the design of the cleaning fluid and the expected functionality of the surfactant having a non-ethoxylated polymerized sugar. In some cases, the amount of the surfactant having a non-ethoxylated polymerized sugar added is great that the surfactant having a non-ethoxylated polymerized sugar is the cleaning fluid.

The cleaning fluid can be prepared and used in several ways, for instance the surfactant having a non-ethoxylated polymerized sugar may be added the fluid at the surface such as inside the blending tank, which in turn may be part of the surface equipment with suction and discharge lines 50, and used in a batch-mixed cleaning fluid. The surfactant having a non-ethoxylated polymerized sugar may be dissolved in a fluid through agitation or by circulating through a tubular or plurality of tubulars. The cleaning fluid may also be mixed or diluted at a mixing facility and transported to the location where it can be used directly or further mixed and added to other fluids or cleaning fluids.

The cleaning fluid may be used to remove the hydrocarbons from the surface equipment 52 by spraying, hosing, or rinsing the surface which needs to be cleaned. Based on the severity of the contamination the cleaning fluid may be heated. The cleaning fluid may also be applied using a pressure washer or other cleaning equipment.

Surface based pipelines and tubulars can be cleaned from the inside to remove hydrocarbons. Contaminants can decrease the inside diameter of the pipeline or other tubulars thereby lowering the transport capacity of the tubings and pipelines. The cleaning fluid may be flushed or pumped through the inside of the tubulars or pipelines.

Optionally the used cleaning fluid is collected in a pit, surface receiving tank, or water recycling facility. The chemical will prevent the formation of an emulsion, allowing for the easy separation of the oil and water phase.

Downhole cleaning can also be carried out with the cleaning fluid. It can be used to remove contaminants from sand, fines, and rock in the wellbore of a production or injection well. The cleaning fluid can also be used to clean downhole equipment such as wellbore casing 54, production tubulars or drill pipes 56, drilling risers, completion risers, workover risers and packers 58. Downhole cleaning of producing or injector wells will in most cases increase the production or injection capacity. Removing contaminants from the wellbore, may increase the flow-thru capacity. If contaminants are removed from the wellbore inside an injector well, the increase in flow through capacity may have a positive impact on the oil production as it allows an increased flow through of injected fluid allowing more oil to be produced out of the reservoir.

The cleaning fluid can be prepared and used in several ways, such as adding the surfactant having a non-ethoxylated polymerized sugar at the surface to the cleaning fluid, such as inside of the blending tank, which can be part of the surface equipment 52 with suction and discharge lines 50. The surfactant having a non-ethoxylated polymerized sugar may be dissolved in a fluid through agitation or by circulating through a tubular or plurality of tubulars. The surfactant having a non-ethoxylated polymerized sugar may also be mixed or diluted with another fluid at a mixing facility and transported to the location where it can be used directly or further mixed. To enhance the effectiveness of the treatment, the cleaning fluid can be heated.

The cleaning fluid can be placed downhole, using a pump 60 which is connected to the surface equipment 52 with suction and discharge hoses 50 by injecting it into the formation via wellbore tubular 56. It can also be applied by circulating with or without partial injection into the formation via the well bore tubulars 56. It can be placed below or above the fracturing pressure of the formation 64. Optionally the cleaning fluid can be allowed to soak to enhance the effectiveness.

The use of a surfactant having a non-ethoxylated polymerized sugar as described in this document mitigates the release of toxic chemicals in the environment, groundwater, sea, or aquifer 10.

In another embodiment of the invention, the surfactant having a non-ethoxylated polymerized sugar is added to a stimulating fluid. The stimulating fluid may be water based and may contain a single other chemical or a plurality of other chemicals.

The purpose of using a stimulating fluid in an oil well is to enhance the recovery of the hydrocarbons present inside a formation. This is referred to as enhanced oil recovery or water flooding.

Enhanced oil recovery is done both on and off shore. A stimulating fluid can be placed in a formation through an injection well 200. The stimulating fluid is pumped into the injection well 200 in order to push hydrocarbons inside the formation towards the production well or plurality of production wells 250 or to build-up or maintain the pressure in the reservoir. In other cases, the injection is done for disposal reasons. This may increase the amount of hydrocarbons produced per day and/or may increase the total volume of hydrocarbons that could be recovered from a hydrocarbon containing downhole reservoir.

The use of the surfactant having a non-ethoxylated polymerized sugar as described herein eliminates or reduces the risk of release of toxic chemicals into the environment, groundwater, sea, or aquifer 10. When preparing the stimulating fluid at surface, as well as during the pumping process, there is a risk of a spill or leakage of the stimulating fluid and chemicals may come in contact with the surface soils, ground water, sea, or aquifer 10. The low toxicity and biodegradability in both fresh and salt water mitigates the release of toxic chemicals into the environment.

The surfactant having a non-ethoxylated polymerized sugar is added to the stimulating fluid. The amount of the surfactant having a non-ethoxylated polymerized sugar added to the stimulating fluid can be between 0.001 and 99% by volume. The percentage by volume of the surfactant having a non-ethoxylated polymerized sugar to the stimulating fluid is based on the design of the stimulating fluid and the expected functionality of the surfactant having a non-ethoxylated polymerized sugar.

If the surfactant having a non-ethoxylated polymerized sugar is added at surface inside a blending tank 202 then it is used in a batch-mixed fluid system. The surfactant having a non-ethoxylated polymerized sugar will be dissolved in the stimulating fluid through agitation or other means.

One purpose of adding the surfactant having a non-ethoxylated polymerized sugar to the stimulating fluid is to lower the surface tension of the stimulating fluid. As a result of lowering the surface tension of the stimulating fluid, the risk that the stimulating fluid emulsifies the hydrocarbons inside the reservoir or formation is eliminated or reduced. Additionally lowering the surface tension of the stimulating fluid reduces the tendency of the stimulating fluid to separate into its component parts while at the surface.

Another purpose of adding the surfactant having a non-ethoxylated polymerized sugar to the stimulating fluid is to reduce the surface tension and increase the contact angle with the reservoir to reduce the capillary pressure of the fluid as the fluid is pumped into the reservoir thereby allowing the fluid greater penetration into the reservoir. Decreasing the surface tension and increasing the contact angle enhances the phase separation of the stimulating fluid and reservoir fluids. The surfactant having a non-ethoxylated polymerized sugar causes the surface of the reservoir to become water wet thereby allowing an easier flow of oil thru the formation which can help in increasing both the production rate and the total volume of recoverable hydrocarbons.

The stimulating fluid is placed inside the well with a pump 204 or by other means, through the wellhead 206 in the workstring 208. The stimulating fluid is then placed inside the formation 212. By placing the stimulating fluid inside the formation 212 it may push some or all of the hydrocarbons, which are present inside the formation 212 towards the production well 250, potentially enhancing the recovery of the oil reserves inside the reservoir.

The use of this surfactant having a non-ethoxylated polymerized sugar mitigates the release of toxic chemicals in the environment, groundwater, sea, or aquifer 10. During the preparation process of the stimulating fluid at surface and during the pumping process, there is a chance due to a spill or leakage of the Injection fluid that chemicals end up interacting with the ground water, sea, or aquifer 10.

The low toxicity and biodegradability in both fresh and salt water cause this surfactant having a non-ethoxylated polymerized sugar mitigates the release of toxic chemicals into the environment.

Multiple environmental tests have been conducted to measure the toxicity and biodegradation of the surfactant having a non-ethoxylated polymerized sugar in both fresh and salt water. The following tests were carried out with the results as mentioned below.

Fresh Water Tests:

| | |
|---|---|
| Biodegradability in fresh water | BOD (60%) = 6 d 6 hr |
| OECD 301D | BOD (70%) = 9 d |
| 48 hr EC50 Acute Toxicity Test - | 113.4 ppm |
| Daphnia Magna | |
| Bacterial Reverse Mutation Assay OECD 471 | No mutagenic effects |
| Salmonella Typhimurium | measured |

The Organisation for Economic Co-operation and Development® or OECD®, has promulgated a test method referred to as OECD® 301 D which permits the screening of a chemical for ready biodegradability in an aerobic aqueous medium in a closed bottle.

The duration of the test can be either 10 or 28 days. In the fresh water test, the biochemical oxygen demand or BOD, of the screened chemical is measured. The BOD is a parameter of the chemicals ready biodegradability. Biochemical oxygen demand is the amount of dissolved oxygen needed by aerobic biological organisms in a body of water to break down organic material present in a given water sample at certain temperature over a specific time period.

EC50 acute toxicity test refers to a test where the effective concentration of a substance that produces acute toxicity in 50% of a population in a given period.

The OECD®, has promulgated another test method referred to as OECD® 471 or the bacterial reverse mutation test. In OECD® 471 an amino-acid requiring strains of Salmonella typhimurium and Escherichia coli is used to detect point mutations, which involve substitution, addition or deletion of one or a few DNA base pairs (1)(2)(3). The principle of this bacterial reverse mutation test is to detect mutations that restore the functional capability of the bacteria to synthesize an essential amino acid. The revertant bacteria are detected by their ability to grow in the absence of the amino acid previously required by the parent test strain.

Salt Water Tests:

| | |
|---|---|
| Biodegradability in seawater OECD 306 | 68% |
| 72 hr EC50 Growth Inhibition Algae - | 84.4 ppm |
| Phaeodactylum Triconutum | |
| 10 Day LC50 Static Sediment Test - | 2976 ppm |
| Corophium Volutator | |
| 96 hr LC50 Marine Fish Toxicity Test - | >113.4 ppm (Could |
| Sheepshead Minnow | not be measured) |

The OECD®, has promulgated another test method referred to as OECD® 306, using sea water, which permits the screening of a chemical for ready biodegradability in an aerobic aqueous medium in a closed bottle.

The duration of the test can be either 10 or 28 days. In this sea water test, the biochemical oxygen demand or BOD, of the screened chemical is measured. The BOD is a parameter of the chemicals ready biodegradability. Biochemical oxygen demand is the amount of dissolved oxygen needed by aerobic biological organisms in a body of water to break down organic material present in a given water sample at certain temperature over a specific time period.

The EC50 growth inhibition algae test refers to a test where the effective concentration of a substance that produces growth inhibition in algae in 50% of a population in a given period.

The LC50 static sediment test refers to a test where the lethal concentration of a substance that kills 50% of a population in a given period.

The LC50 marine fish toxicity test refers to a test where the lethal concentration of a substance that kills 50% of a population in a given period.

In order to measure functionality of the surfactant, the following tests were carried out to measure how it reduces the surface tension of 3% KCl brine according to the ISO 304:1978 lab protocol, titled “Surface Active Agents—Determination of Surface Tension by Drawing Up Liquid Films.”

Test Description;

Surfactant @0.2% in 3% KCl solution.

The surface tension of each sample was measured using a Data Physics DCAT 21 tensiometer and the Wilhemy plate method.

The test liquid was poured into a boro-silicate glass beaker. The beaker was placed into the test equipment preconditioned by mixing for 30 seconds using a magnetic stirrer and rested for a further 30 seconds prior to testing.

The plate was cleaned in acetone and demineralised water before being heated until the plate glowed red. It was then allowed to cool before being placed in the equipment.

Appropriate data was entered into an automated measurement program. The plate was then slowly lowered until it touched the surface of the test liquid. The plate was lowered an additional 3 mm and then withdrawn until the lower edge of the plate was coincident with initial position of the liquid surface.

The weight change of the plate was recorded by the tensiometer and the software calculated the surface tension. When the surface tension had stabilised (SD<0.05 mN/m) typically 15 s after the plate first touched the liquid, the software terminated the measurement and the data was stored. Each liquid was measured twice. The plate was cleaned between each measurement.

The surfactant lowered the surface tension of the 3% KCl brine at a dosage rate of 0.2% to a level of 35 Dynes/cm at room temperature.

While the embodiments are described with reference to various implementations and exploitations, it will be understood that these embodiments are illustrative and that the scope of the inventive subject matter is not limited to them. Many variations, modifications, additions and improvements are possible.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A fluid system for treating a well comprising:
a surfactant having a non-ethoxylated polymerized sugar,
wherein the surfactant is free from an alkylphenol group,
further wherein the surfactant is free from 1,4 dioxane.

2. The fluid treatment system of claim 1, wherein the surfactant has a phosphate group and an alkyl chain having from 8 to 22 carbon atoms.

3. The fluid treatment system of claim 1, wherein the surfactant has a sulfate group and an alkyl chain having from 8 to 22 carbon atoms.

4. The fluid treatment system of claim 1, wherein the surfactant has a sulfosuccinate group and an alkyl chain having from 8 to 22 carbon atoms.

5. The fluid treatment system of claim 1, wherein the surfactant has a carboxylate group and an alkyl chain having from 8 to 22 carbon atoms.

6. The fluid treatment system of claim 1, wherein the surfactant is derived from a renewable source.

7. The fluid treatment system of claim 6, wherein the renewable source is coconut oil.

8. The fluid treatment system of claim 6, wherein the renewable source is linseed oil.

9. The fluid treatment system of claim 6, wherein the renewable source is rapeseed oil.

10. A method of treating a well comprising:
mixing a surfactant having a non-ethoxylated polymerized sugar with a fluid
wherein the surfactant is free from an alkylphenol group
further wherein the surfactant is free from 1,4 dioxane,
pumping the fluid and the surfactant into a well,
pressurizing the fluid and the surfactant within the well, and
causing fractures within a formation.

11. The method of claim 10, wherein the fluid is water.

12. The method of claim 10, wherein the surfactant has a phosphate group and an alkyl chain having from 8 to 22 carbon atoms.

13. The method of claim 10, wherein the surfactant has a sulfate group and an alkyl chain having from 8 to 22 carbon atoms.

14. The method of claim 10, wherein the surfactant has a sulfosuccinate group and an alkyl chain having from 8 to 22 carbon atoms.

15. The method of claim 10, wherein the surfactant has a carboxylate group and an alkyl chain having from 8 to 22 carbon atoms.

16. The method of claim 10, wherein the surfactant is derived from a renewable source.

17. The method of claim 10, wherein the renewable source is coconut oil.

18. The method of claim 10, wherein the renewable source is linseed oil.

19. The method of claim 10, wherein the renewable source is rapeseed oil.

20. The method of claim 10, wherein the surfactant lowers the surface tension of a water-based fluid.

21. The method of claim 10, wherein the surfactant decreases the contact angle between a hydrophilic fluid and a hydrophobic fluid.

22. The method of claim 10, wherein the surfactant reduces the friction of the water-based fluid.

23. The method of claim 10, wherein the surfactant prevents the emulsification of a hydrocarbon in the well.
